(19) United States
(12) Patent Application Publication
(10) Pub. No.: US 2006/0015685 A1
(43) Pub. Date: Jan. 19, 2006

(54) Cache controller, cache control method, and controller

(75) Inventor: Masayuki Daito, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/175,446

(22) Filed: Jul. 7, 2005

(30) Foreign Application Priority Data
Jul. 15, 2004 (JP) 2004-209039

(51) Int. Cl. G06F 12/00

(52) U.S. Cl. 711/118; 711/133

(57) ABSTRACT

Disclosed is a controller which includes a CPU, a cache control unit, a tag control unit, a data unit, and a ROM. The cache control unit executes cache control operations for a process executed on the CPU, based on the process identifier in one of cache access modes: (A) cache nonuse, (B) cache use with block replacement permission, and (C) cache use with block replacement no-permission. The cache cannot be used when control information corresponding to a process identifier indicates (A), but can be used when control information indicates (B). When control information indicates (C), an instruction is sent from the cache to the CPU if a cache hit occurs, and from the ROM to the CPU if a cache miss occurs, but a block replacement is not executed.

### FIELD OF THE INVENTION

The present invention relates to a cache controller, a cache control method, and a controller that has the cache controller.

### BACKGROUND OF THE INVENTION

A cache is used for increasing the average access speed of a relatively slow memory arranged outside an LSI. As is well known, a cache improves the execution performance of a program with the principle of locality (temporal locality and spatial locality) and hence is widely used in the field of signal processing and computation processing. Temporal locality and spatial locality are respectively stated as follows:

Temporal locality (locality in time)—if an item is referenced, the item will tend to be referenced again soon.

Spatial locality (locality in space)—if an item is referenced, items of nearby addresses will tend to be referenced soon.

To fully utilize the spatial locality of a program, the cache block should be a predetermine size larger than one word. It is known that an increase in the cache block size results in a reduction in the miss ratio (see Non-Patent Document 1 given below).

Although a cache improves the execution performance of a program, it also has the following demerits:
Is difficult to estimate the worst execution time
Does not achieve an anticipated effect in some programs

The following describes some of the typical architectures. FIG. 5 shows an example of the typical configuration of a controller LSI (semiconductor integrated circuit) designed for control operations in a unit such as an ECU (Engine Control Unit).

Referring to FIG. 5, an LSI 10A comprises a RAM (Random Access Memory) 12, a ROM (Read Only Memory) 13, and a CPU (Central Processing Unit) 11 (with no cache), all of which are on one chip as an instruction-execution architecture of the CPU for control operations. The ROM 13, which is a memory such as a flash memory (EEPROM: Electrically programmable ROM that is erasable in sectors), stores non-volatile data composed of instructions executed by the CPU 11 or instructions and data executed and referenced by the CPU 11. The CPU 11 reads data from and writes data to the RAM 12. FIG. 5 shows only the configuration of instruction and data paths but does not show other components such as an input/output controller.

In the configuration shown in FIG. 5, the CPU 11 accesses the instructions stored in the ROM 13 at a high speed to improve performance and, because no cache is installed, executes operation at a constant speed. The configuration shown in FIG. 5 makes it easier to estimate the worst execution time.

However, in the configuration shown in FIG. 5, if the access time of the ROM 13 becomes slower than the operation speed of the CPU 11, the performance is degraded.

Recently, the operation frequency of the CPU is greatly increased. In contrast, because of the LSI fabrication process, the speed (an access time) of a ROM (flash memory) is not made so much fast as that of the CPU. That is, because of a difference in the increase of speed between the ROM (flash memory) and the logic unit, it becomes increasingly difficult to implement a ROM (flash memory) that operates at the speed of a high-speed CPU that operates at a frequency band of 100 MHz to 200 MHz.

This leads to the configuration in which a cache is provided between the CPU and the ROM arranged in the LSI. FIG. 6 is a diagram showing an example of a typical configuration in which a cache is provided between the CPU and the ROM.

As shown in FIG. 6, a controller LSI 10B comprises a CPU 11A, an instruction cache 15, a data cache 16, and a memory controller 14. A RAM device 12E and a ROM device 13E are provided outside the controller LSI 10B. The memory controller 14 included in the controller LSI 10B, which has a bus controller not shown, is connected to the RAM device 12E and the ROM device 13E via a bus. Responsive to an address signal and a read command from the CPU 11A, the memory controller 14 controls the reading of an instruction from the ROM device 13E or, in response to an address signal and a read command from the CPU 11A or in response to an address signal, a write command, and a data signal from the CPU 11A, the memory controller 14 controls the reading of data from the RAM device 12E or controls the writing of data into the RAM device 12E.

If a cache hit occurs when a read access is made from the CPU 11A, the corresponding instruction stored in the instruction cache 15 is supplied to the CPU 11A; if a cache miss occurs, a plurality of instructions (one block of instructions) including the instruction to be accessed are read from the ROM device 13E. In the instruction cache 15, some instructions (a block of instructions) are replaced by the instructions (a block of instructions) read from the ROM device 13E. If a cache hit occurs when a read access is made to the data cache 16, the corresponding data stored in the data cache 16 is supplied to the CPU 11A; if a cache miss occurs, a plurality of data items (one block of data) including the data to be accessed are read from the RAM device 12E. In the data cache 16, some data items are replaced by the block read from the RAM device 12E.

The configuration shown in FIG. 6 is not affected much by the speed of an external memory but provides average performance.

Another known architecture is that a controller LSI 10C has a cache 20 between the CPU 11 and the ROM 13, as shown in FIG. 7. The configuration shown in FIG. 7 ensures “high average performance” that is one of the merits of a cache. In FIG. 7, the ROM 13 pre-stores instructions executed in the CPU 11 and the RAM 12 stores write data written by the CPU 11, as is described in FIG. 5. The cache 20 stores instructions read from the ROM 13. If a cache hit occurs when a read access is made from the CPU 11, the corresponding instruction stored in the cache 20 is supplied to the CPU 11; on the other hand, if a cache miss occurs, one block of instructions including the instruction to be accessed are read from the ROM 13. In the cache 20, some instructions are replaced by the block (instructions) read from the ROM 13 and the instruction to be accessed is supplied to the CPU 11.

For a document describing a technology for controlling a cache in a configuration where the cache is provided between a flash memory and a CPU, also see Patent Document 1. The Patent Document 1 discloses a configuration where a read/write request for a flash memory is executed by accessing the flash memory in units of sectors each composed of a plurality of pages, whether or not the write data of a sector is valid is checked for each page, and data determined to be invalid is not allocated to the data storage area of the flash memory.

[Patent Document 1]

Japanese Patent Kokai Publication No. JP-A-7-146820 (FIG. 1)

[Non-Patent Document 1]

John L. Hennessy, David A. Patterson, “Computer Organization and Design”, Morgan Kaufmann Publishers Inc., pp. 454-455, p. 480, 1994.

### SUMMARY OF THE DISCLOSURE

One of the problems with the configuration shown in FIG. 7 is that, though “high average performance” that is a merit of a cache is achieved, the following demerits of the cache remain unresolved.
Is difficult to estimate the worst execution time
Does not achieve an anticipated effect in some programs

FIG. 8 is a diagram showing the relation between the cache hit ratio and the CPU performance for the design methods shown in FIG. 5, FIG. 6, and FIG. 7. FIG. 8 shows the result of analysis made by the inventor of the present invention for describing the problems of the conventional design methods. The measurement result shown in FIG. 8 assumes following configuration. That is, the LSI 10B in the configuration in FIG. 6 comprises a double data rate interface (DDR-I/F) at the operating frequency of 133 MHz and, as the ROM device 13E, a flash memory having the access time of 40 ns (nanosecond). The LSI 10A in FIG. 5 and the LSI 10C in FIG. 7 use an on-chip flash memory with the access time of 100 ns as the internal ROM 13. The CPUs in FIG. 5 to FIG. 7 are virtually driven at 266 MHz (one instruction≈3.76 ns).

In FIG. 8, the performance ‘a’ indicates the target performance, and the performance ‘b’ indicates the performance characteristic of the configuration shown in FIG. 5 (The performance is represented by a fixed value because no cache is used). The performance ‘c’ indicates the performance characteristic of the configuration shown in FIG. 6. The performance ‘d’ indicates the performance characteristic of the configuration shown in FIG. 7.

Although the configuration shown in FIG. 5 achieves a predetermined processing performance as shown by the characteristic ‘b’ in FIG. 8, the performance is much lower than the target performance. To attain near-target performance in the configuration shown in FIG. 5, it is required to further increase the speed of the faster flash memory (13 in FIG. 5). This will result in a significant increase in the cost.

The characteristic ‘c’ in FIG. 8 indicates that the configuration shown in FIG. 6 can achieve an average performance without being affected by the speed of the external ROM device 13E. That is, this configuration achieves the target performance at the cache hit ratio of 99%, provides better performance than that of the characteristic ‘b’ at the cache hit ratio of about 95% or higher, and provides much better performance than that of the characteristic ‘d’ even at the cache hit ratio of 91%.

The characteristic ‘d’ in FIG. 8 indicates that the configuration shown in FIG. 7 sometimes falls to about ⅓ of the target performance at the hit ratio of about 91%. The characteristic ‘d’ in FIG. 8, whose performance varies three times from the highest to the lowest according to a variation in the hit ratio, is sometimes inappropriate as a controller LSI for control operations. This is because a controller LSI for control operations is preferably required to have a predetermined high performance in order to precisely execute real-time control operation where the response time is very strict. In addition, even if the performance varies, the controller LSI is required to estimate the worst execution time precisely.

The present invention disclosed in the present application has the following configuration.

A cache controller according to one aspect of the present invention comprises a storage unit in which at least one correspondence between process identifier information (process ID”) and configuration information specifying a cache access mode is stored; and a control circuit that receives a process ID supplied from a CPU, obtains configuration information corresponding to the process ID from the storage unit and, based on the configuration information, variably controls the access mode of a cache for a process executed in the CPU.

The cache controller according to the present invention preferably has a configuration in which the cache access mode is variably controlled according to execution characteristics of the process.

The cache controller according to the present invention preferably has a configuration in which, as the correspondence between the process ID and the configuration information, the storage unit stores at least one of correspondences of

process ID and cache nonuse,

process ID and cache use with permission of cache contents replacement, and

process ID and cache use with no-permission of cache contents replacement, and

in which the cache access controller receives the process ID from the CPU, obtains configuration information corresponding to the process ID from the storage unit, and, based on the configuration information, controls the cache use and nonuse and/or the permission and no-permission of cache contents replacement for a process executed in the CPU.

A cache controller according to another aspect of the present invention comprises a storage unit in which at least one piece of configuration information is stored, the configuration information specifying a correspondence between process identifier information (called “process ID”) and cache use/nonuse, wherein the cache controller receives a process ID from a CPU, obtains configuration information corresponding to the process ID from the storage unit and, based on the configuration information, controls cache use and nonuse for each process.

A cache controller according to another aspect of the present invention comprises a storage unit in which at least one piece of configuration information is stored, the configuration information specifying a correspondence between process identifier information (called “process ID”) and permission/no-permission of cache contents replacement, wherein the cache controller receives a process ID from a CPU, obtains configuration information corresponding to the process ID from the storage unit and, based on the configuration information, controls permission/no-permission of cache contents replacement for each process.

The above-described cache controller according to the present invention can have a configuration in which the correspondence between the process ID and the configuration information is set associated with characteristics of an execution program managed by an operating system running in the CPU.

A controller according to another aspect of the present invention comprises a CPU; a cache; and the above-described cache controller according to the present invention. The controller according to the present invention can have a configuration in which a storage unit in which data and/or instructions are stored is provided internally or externally to the controller.

In the controller according to the present invention, if the configuration information corresponding to the process ID indicates cache nonuse and when a read access is made from the CPU, the cache is not accessed but contents read from the storage unit are sent to the CPU.

In the controller according to the present invention, if the configuration information corresponding to the process ID indicates cache use with permission of cache contents replacement (such as block replacement) and when a read access is made from the CPU, contents read from the cache are sent to the CPU if a cache hit occurs, while contents read from the storage unit are sent to the CPU and, at the same time, the cache contents are replaced with the contents read from the storage unit if a cache miss occurs.

In the controller according to the present invention, if the configuration information corresponding to the process ID indicates cache use with no-permission of cache contents replacement (such as block replacement) and when a read access is made from the CPU, contents read from the cache are sent to the CPU if a cache hit occurs, while contents read from the storage unit are sent to the CPU and the cache contents are not replaced with the contents read from the storage unit if a cache miss occurs.

A cache control method according to another aspect of the present invention comprises

(a1) a step by a CPU for supplying process identifier information (called “process ID”) of processes, executed in the CPU, to a cache controller

(a2) a step by the cache controller for receiving a process ID from the CPU and obtaining configuration information corresponding to the process ID by referencing a storage unit in which at least one correspondence between a process ID and configuration information specifying a cache access mode is stored and

(a3) a step by the cache controller for variably controlling the cache access mode of the process based on the configuration information.

The cache control method according to the present invention can have a configuration in which the cache access mode is variably controlled according to execution characteristics of the process.

The cache control method according to the present invention may be a method wherein, as the correspondence between the process ID and the configuration information,

the storage unit stores at least one of correspondences of

process ID and cache nonuse,

process ID and cache use with permission of cache contents replacement, and

process ID and cache use with no-permission of cache contents replacement, and

wherein the process ID is received from the CPU, configuration information corresponding to the process ID is obtained from the storage unit, and, based on the configuration information, the cache use and nonuse and/or the permission and no-permission of cache contents replacement for a process executed in the CPU are controlled.

The cache control method according to the present invention may be a method wherein the correspondence between the process ID and the configuration information is set associated with characteristics of an execution program managed by an operating system running in the CPU.

The meritorious effects of the present invention are summarized as follows.

The cash controller and the cash control method according to the present invention variably control the cache based on the execution characteristics of a program to make it easy to estimate the worst execution time even for a program having low temporal and spatial locality and to provide expected performance.

Still other effects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the configuration of one preferred embodiment of the present invention.

FIG. 2 is a diagram showing the configuration of one embodiment of the present invention.

FIG. 3 is a diagram showing the change characteristics of instruction-miss ratios for various cache sizes.

FIG. 4 is a flowchart showing the processing procedure of one embodiment of the present invention.

FIG. 5 is a diagram showing one example of a conventional configuration.

FIG. 6 is a diagram showing one example of a conventional configuration.

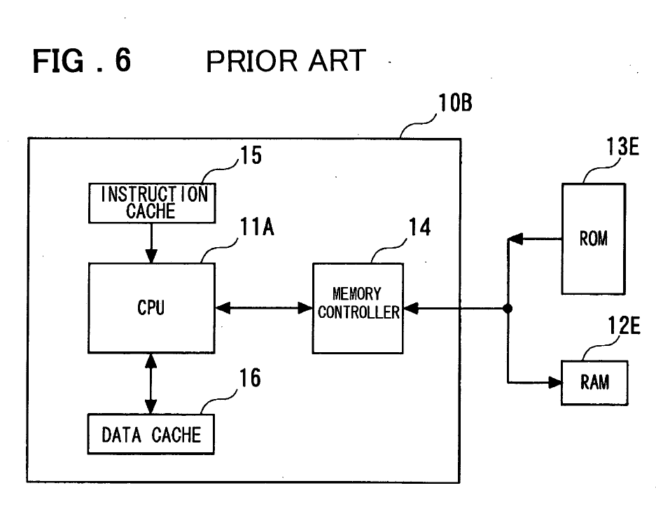

FIG. 7 is a diagram showing one example of a conventional configuration.

FIG. 8 is a diagram showing the analysis result of cache hit ratios versus performance characteristics in a conventional configuration.

### PREFERRED EMBODIMENTS OF THE INVENTION

The operation principle and preferred embodiments of the present invention will be described below with reference to the accompanying drawings. First, the following describes the principle of the present invention.

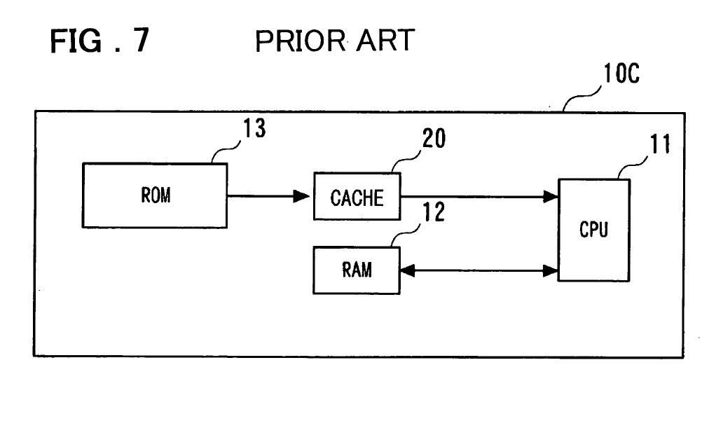

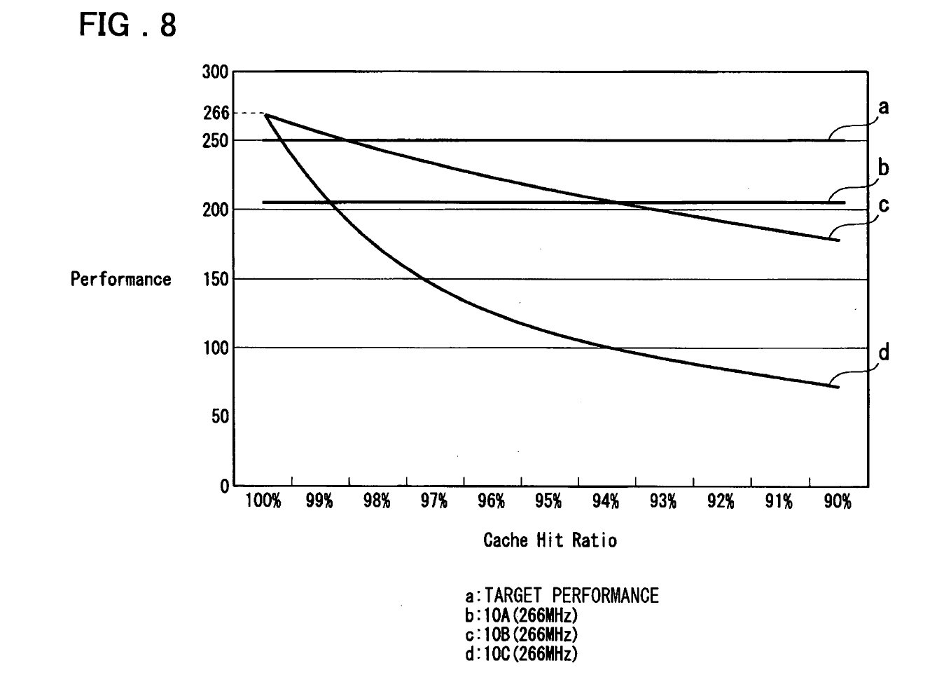

As described above, the performance degradation caused by the reduction in the cache hit ratio in the configuration shown in FIG. 7 is so serious (see characteristics d in FIG. 8) that it is difficult to estimate the worst execution time accurately. This means that it is difficult to use the configuration shown in FIG. 7 as a controller for control operations.

A further study made by the inventor of the present invention indicates that a program executed by the CPU for control operations has low temporal/spatial locality. One of possible reasons for this is that the CPU for control operations is driven primarily by an external interrupt.

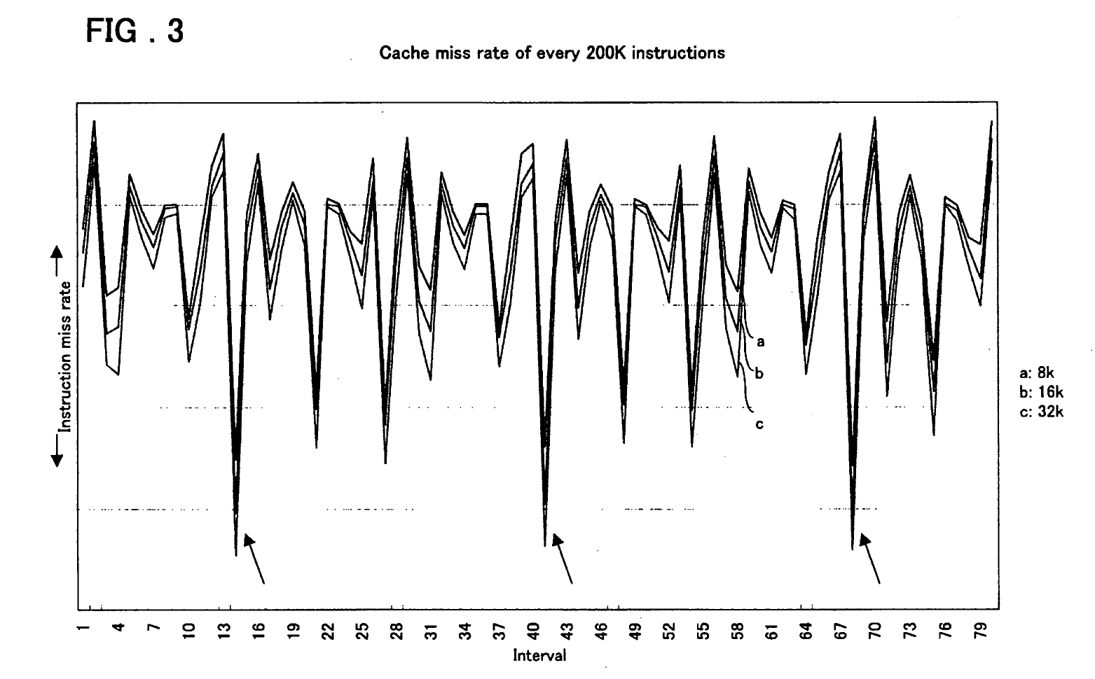

FIG. 3 is a diagram showing the analysis result of the transition of instruction miss ratios during the execution of a program prepared for control operations. That is, FIG. 3 shows the measurement result of instruction miss ratios (=(100-cache hit ratio)%) for three memory sizes of the cache 20, 8K bytes, 16K bytes, and 32K bytes, in the configuration shown in FIG. 7 (in which the ROM, the cache, and the CPU are mounted on the LSI). The cache 20 has a 4-way set associative configuration, and the instruction miss ratios for each of 200×1000 (200K) times of instruction executions are plotted. That is, one interval of the horizontal axis in FIG. 3 corresponds to a time interval required for 200×1000 (200K) times of instruction execution, and the vertical axis in FIG. 3 indicates the instruction miss ratio (shown in %). In FIG. 3, the symbols “a”, “b”, and “c” represent the transition of instruction miss ratios when the cache size is 8K bytes, 16K bytes, and 32K bytes, respectively. Note that, if the 8K-byte cache comprises 2K entries each block of which is 4 bytes in size, the 16K-byte cache comprises 2K entries each block of which is 8 bytes in size and the 32K-byte cache comprises 2K entries each block of which is 16 bytes in size.

In FIG. 3, it should be noted that there is no noticeable difference in the change of instruction miss ratios even when the size (8K bytes) of the cache 20 is doubled or quadrupled. That is, though the hit ratio in a program having spatial locality is expected to increase as the cache 20 is increased in size (block size), the analysis result in FIG. 3 does not show such a tendency. That is, the analysis result shows that the program has no spatial locality. The changes in the characteristics a, b, and c also indicate that the program has no temporal locality (this locality refers to the tendency that data near once-reference data will be referenced soon). Note that, in FIG. 3, the time at which the instruction miss ratio of the characteristics a, b, and c starts to rise from the bottom value to the peak value corresponds to a time when the CPU 11 in FIG. 7 performs context switching and switches the task from an old process (task) to a new process (task) for starting the execution of the new process (task). In this case, the cache 20 (see FIG. 7) is not likely to store the instructions in the new process (task) with the result that the instruction miss ratio rapidly reaches the peak. After that, as the process (task) processing proceeds, cache misses occur and the old instructions are gradually replaced with the instructions related to the process (task) read from the ROM 13 (see FIG. 7). This causes the instruction miss ratio of the cache 20 (see FIG. 7) to fall. The frequency indicated by the arrows in FIG. 3 corresponds to the frequency (type) of a program that is executed.

The present invention is based on a known fact about the cache performance characteristics specific to a program adapted for control operations (that is, such a program sometimes does not have temporal/spatial locality). The present invention provides a configuration in which the control mode of the cache is changed according to the execution characteristics of a program executed in the CPU. The following describes the preferred embodiment more in detail.

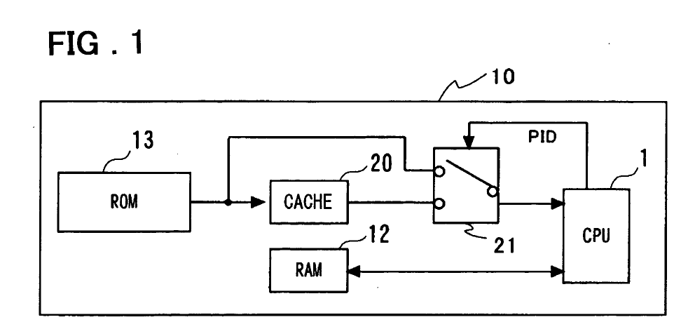

FIG. 1 is a diagram showing the configuration of one preferred embodiment of the present invention. Referring to FIG. 1, an LSI 10 has a cache 20 between a CPU 1 and a ROM 13 and, in addition, has a cache control circuit 21 that controls whether to use the cache for a process ID (process identifier, also abbreviated “PID”) output from the CPU 1. In addition, in one preferred embodiment of the present invention, the cache control circuit 21 not only switches whether to use the cache but also, when the cache is used, controls whether to permit each process ID to replace the contents of the cache.

To make it easier to estimate the worst execution time, the programs prepared for the control operations are divided generally into the following two:

(A) Program (process or task) requiring the guarantee of worst execution time.

(B) Program (process or task) not requiring the guarantee of execution time.

There are the following two types of “program requiring the guarantee of worst execution time” in (A):

(A1) Program for which constant execution time must be guaranteed.

(A2) Program for which execution within a predetermined time must be guaranteed.

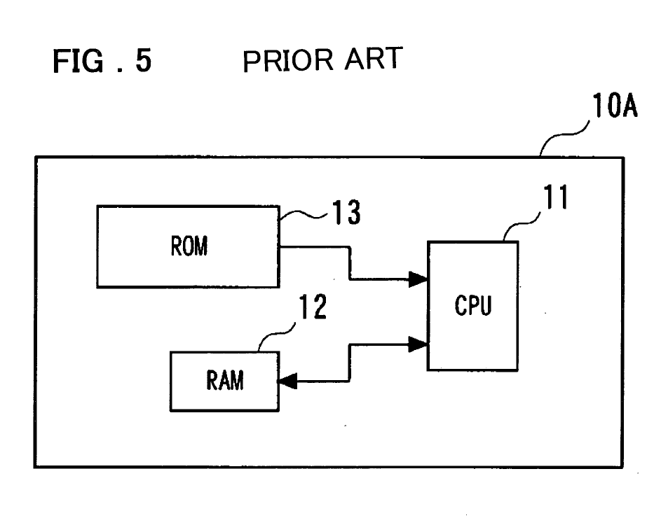

In the present embodiment, the cache is not used for “a program (process) for which constant execution time must be guaranteed” listed in (A1) described above. That is, in this case, the cache control circuit 21 allows the CPU 1 to directly access the ROM 13 for reading data not via the cache 20. In this case, the configuration in FIG. 1, which is equivalent to the configuration shown in FIG. 5, ensures constant performance.

For “a program (process) for which execution within a predetermined time must be guaranteed” listed in (A2) described above, the cache control circuit 21 permits the CPU 1 not only to access, but also to replace the contents of, the cache 20.

In contrast, for “a program not requiring the guarantee of execution time” listed in (B) described above, the cache control circuit 21 permits the CPU 1 only to access, but not to replace the contents of, the cache 20.

The cache control circuit in this preferred embodiment controls access to the cache as described above to make it easier to estimate the worst execution time of a program prepared for control operations.

Meanwhile, one of the reasons for not attaining an “expected effect” in the cache system is that the cache size is too small for the whole operation space (address space) of a program. The cache, if too small in size, causes thrashing in the cache and degrades the temporal locality and the spatial locality.

In the present embodiment, the cache control circuit 21 controls access to the cache 20 according to a process executed in the CPU 1 as described above for controlling the cache according to the program execution characteristics. Therefore, this configuration can reduce the total number of programs that would replace the content of the cache (exchange the contents of the cache by a block read from the memory) when an instruction miss occurs. That is, according to the execution characteristic of each process, a setting can be specified so that one process can use the cache but cannot replace the content of the cache, another process cannot use the cache, and many instruction codes are stored in the cache a particular process. This configuration can decrease the total amount of cache contents that are replaced due to miss hits. A decrease in the number of cache replacements is equivalent to an increase in the ratio of the cache size to the operation space of the whole program, thus making it possible to increase the average performance when the cache is used.

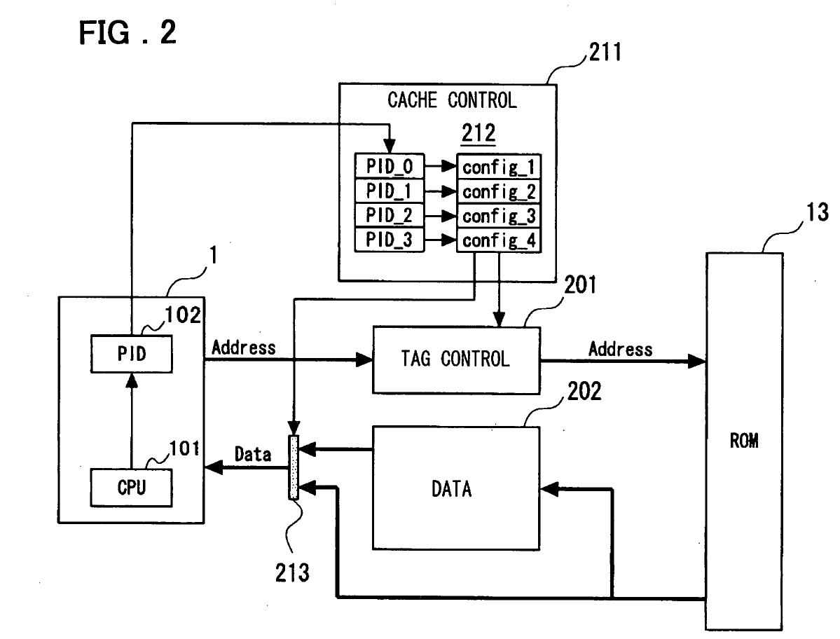

FIG. 2 is a diagram showing the configuration of an LSI (controller) according to one embodiment of the present invention. Referring to FIG. 2, the controller according to the present embodiment comprises a tag control unit 201 and a data unit 202 between a CPU 1 and a ROM 13 that is a flash memory. The controller further comprises a cache control unit 211 and a selector 213 that, in response to a control signal from the cache control unit 211, selects one of data (instruction) read from the ROM 13 and data (instruction) read from the data unit 202 and outputs the selected data to the CPU 1. The tag control unit 201 and the data unit 202 constitute the cache 20 in FIG. 1, and the cache control unit 211 and the selector 213 correspond to the cache control circuit 21 in FIG. 1.

The tag control unit 201 has a known configuration having a plurality of entries (not shown), in which tag addresses are stored, and a comparator (not shown) that compares the tag address (a field of a predetermined number of high-order bits including the MSB (Most Significant Bit)) of an address signal received from the CPU 1 with the tag address of an entry referenced by the index (a field of a predetermined number of bits that are in the bits lower than the tag address) of the address signal. If the tag addresses match, the comparator not shown determines that a cache hit occurred; if the tag addresses mismatch, the comparator determines that a cache miss occurred. The data unit 202 has a known configuration in which there are a plurality of blocks which correspond to the plurality of entries each containing a tag address and each of which stores multiple bytes of data. When a cache hit occurs, the block is accessed based on the index of the address signal and the corresponding data is selected for output based on the low-order bits including the LSB (Least Significant Bit) of the address signal. Of course, the cache may have a multiple-way set associative configuration. When the contents of the cache are replaced (exchange of blocks) in a multiple-way set associative configuration, a block to be replaced is selected based on the LRU (Least Recently Used) method or randomly.

The cache control unit 211 has a storage unit 212 in which the correspondence between process IDs and configuration information (config) is stored in a tabular format. The storage unit 212 receives a process ID that is output from the CPU 1 and outputs configuration information corresponding to the process ID. The cache control unit 211 outputs a control signal, which corresponds to the contents of the configuration information from the storage unit 212, to the tag control unit 201 and the selector 213. The correspondence between process IDs and configuration information (config) stored in the storage unit 212 is set up by the CPU 1, for example, at boot time (power-up time or reset time). It is of course possible to employ a configuration that allows the CPU 1 to variably set up the correspondence between process IDs and configuration information (config) stored in the storage unit 212 as necessary.

If the contents of the configuration information corresponding to a process ID from the CPU 1 indicates that the cache is not used, the cache control unit 211 controls the cache as follows. That is, the tag control unit 201 does not determine the occurrence of a cache hit but supplies the address signal, received from the CPU 1, directly to the ROM 13, and the selector 213 selects the data (instruction) read from the ROM 13 and sends it to the CPU 1.

If the contents of the configuration information corresponding to a process ID from the CPU 1 indicate that the cache is used but the replacement is not permitted, the cache control unit 211 control the cache as follows. When a cache miss occurs, the replacement of data in the data unit 202 with data (instruction) read from the ROM 13 is inhibited. That is, when a cache hit occurs, the data (instruction) read from the data unit 202 is supplied to the CPU 1 via the selector 213; when a cache miss occurs, the data (instruction) read from the ROM 13 is supplied to the CPU 1 but the data in the data unit 202 is not replaced with the data (instruction) read from the ROM 13.

On the other hand, if the contents of the configuration information corresponding to a process ID from the CPU 1 indicate that the cache is used and the replacement is permitted, the cache control unit 211 controls the cache as follows. That is, when a cache hit occurs, the data read from the data unit 202 is supplied to the CPU 1 via the selector 213. When a cache miss occurs, the data (instructions) read from the ROM 13 is supplied to the CPU 1 and the data in the data unit 202 is replaced with the data (instructions) read from the ROM 13.

The CPU 1 sets up a unique ID (process ID) for each process that is the management unit of a program to be executed. A process is managed by the OS (Operating System) executed on the CPU 1. In FIG. 2, the numeral 102 indicates a register in which the ID of a process executed by a CPU core 101 is stored.

In the present embodiment, the following can be set independently for each process ID.
Cache access permission/no-permission; and
Block replacement permission/no-permission

In the present embodiment, when a program is executed on the CPU 1, the CPU 1 associates the process ID that is set by the OS (Operating System) with the configuration information on the cache and notifies the configuration information to the cache control unit 211. In the example shown in FIG. 2, when the process ID (PID) from the CPU 1 is PID_0, the cache control unit 211 outputs the configuration information config_1 from the storage unit 212 and, when the process ID (PID) from the CPU 1 is PID_1, the cache control unit 211 outputs the configuration information config_2 from the storage unit 212.

Depending upon the configuration information output from the storage unit 212, the cache control unit 211 executes the control operation in one of the following three modes:

(A) Cache access permission and block replacement permission;

(B) Cache access permission and block replacement no-permission; and

(C) Cache access no-permission

A program that always requires a constant execution time is executed in the mode (C) described above with the cache access not permitted.

A program that must be executed within the worst execution time is executed by accessing the cache in the mode (A) described above.

Other programs are executed by accessing the cache in the mode (B) described above.

In the present embodiment, which mode to select from (A) to (C) is set according to the “execution program property” managed by the operating system (OS) running on the CPU 1. This selection is not dependent on an address at which the program is allocated.

In the present embodiment, one of (A) to (C) described above is selected according to the execution property of each program (process) and the cache control mode is switched for each process for executing the program. This configuration enables:
a program to be executed in a state in which the maximum execution time is guaranteed if the maximum execution time must be guaranteed; and
a program to be executed in a state in which the cache effect is maximized if the average processing time is important.

In the present embodiment, only programs whose average processing time is important can be selected from other programs for execution. This prevents the performance from being degraded when the cache memory, smaller than ROM 13 in capacity, is used.

In addition, the execution program property information managed by the OS (Operating System) and the cache use permission/no-permission mode can be associated and set in the present embodiment. This allows a program to be executed in a system configuration according to the execution property of the program without changing the program allocation addresses and program contents.

Furthermore, not only the two cache modes (that is, use/nonuse) but also the use mode that inhibits only the cache replacement can be set for each process in the present embodiment. This allows the contents already stored in the cache to be fully utilized.

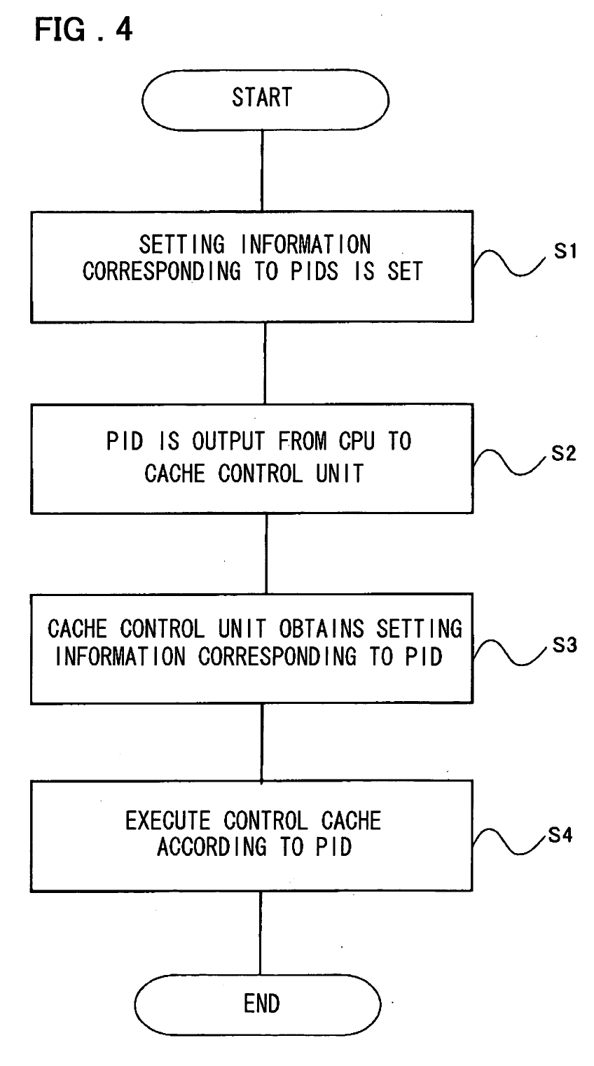

FIG. 4 is a flowchart for showing the operation procedure of one embodiment of a cache control method according to the present invention. The following describes the procedure in this embodiment with reference to FIG. 2 and FIG. 4.

In step S1, the correspondence between process IDs (PIDs) and configuration information is set from the CPU 1 to the storage unit 212 of the cache control unit 211.

In step S2, the CPU 1 outputs the process ID of a process to be executed in the CPU 1 to the cache control unit 211.

In step S3 that follows, the cache control unit 211 receives the process ID supplied from the CPU 1 and obtains the configuration information corresponding to the process ID from the storage unit 212.

In step S4 that follows, the cache control unit 211 executes the cache control operation (cache nonuse, cache use with replacement permission, and cache use with replacement no-permission) according to the process ID for the process executed in the CPU 1 based on the obtained configuration information.

### COMPARATIVE EXAMPLE 1

Next, as a comparative example of the present invention, a configuration in which the cache control mode is selected not for a process ID but for each accessed area (address) will be described. In such a configuration, the cache permission mode, that is, cache permission and no-permission, can be set for each area allocated to specific addresses. A program allocated to the address for which cache permission is specified executes operations using the cache, while a program allocated to the addresses for which cache no-permission is specified executes operations without using the cache. However, because cache operation permission/no-permission can be controlled only for the memory addresses allocated to the program in this case, cache permission/no-permission cannot be controlled flexibly for a nearby allocated program. For example, the runtime routines of the C language are controlled in such a way that only some runtime routines used by a particular program are stored in the cache but others are not. Similarly, the interrupt processing routines are set in such a way that some interrupt processing routines are stored in the cache but others are not. However, it is difficult to change the cache use/nonuse mode for each program at system startup time and, therefore, optimum cache use cannot be decided on a system basis.

### COMPARATIVE EXAMPLE 2

In addition, as another comparative example of the present invention, a configuration in which the cache permission/no-permission mode is explicitly specified and switched in a program will be described. In this configuration, a program is run using the cache from the moment cache permission is explicitly specified in the program, and without using the cache from the moment cache no-permission is explicitly specified in the program. However, this configuration has the following problems.

(I) Cache permission/no-permission must be switched in a program.

(II) The cache permission mode is difficult to control because the state before the switching depends on the setting of the program previously executed.

(III) In a system where the program execution order is controlled by the OS (Operating System), only the OS can manage the cache control but a program that is executed has no means for changing the cache control.

As described above, there are the following problems in both comparative examples 1 and 2. A program can benefit from the cache when a cache access is permitted; however, when a cache access is not permitted, the program cannot access desired data even if it is stored in the cache but must read the data from the memory.

Only an access address is given from the CPU to the cache system and hence the cache system can change the cache control mode based only on the access address information. In a system where the OS (Operating System) is installed, the OS manages the program execution order and the program execution states for each program, but there is no OS-managed information for controlling the cache.

### PRESENT INVENTION

Unlike the comparative examples 1 and 2 described above, one of the following modes can be selected in the present embodiment for switching the cache control mode according to the execution property of a program.

(A) Cache access permission and block replacement permission

(B) Cache access permission and block replacement no-permission

(C) Cache access no-permission

This control mode allows:

a program to be executed in a state where the maximum execution time is guaranteed when the maximum execution time of the program must be guaranteed.
a program to be executed in a state where the effect of the cache is maximized when the average processing time of the program is important.

In addition, the correspondence between the program execution property information managed by the OS (Operating System) and the cache use/nonuse mode can be set in the present embodiment. Therefore, a program can be executed in the present embodiment in a system configuration adjusted to the program execution property without changing the program allocation addresses and contents of the program.

Although the present invention has been described in accordance with the embodiment described above, it is to be understood that the present invention is not limited to the configuration of the above embodiment. The present invention, of course, includes various changes and modifications that may be thought of by those skilled in the art.

For example, although the RAM, the ROM, and the cache are mounted on the same chip as that of the LSI in the present embodiment, a RAM and a ROM may as a matter of course be provided outside the LSI. In addition, although the cache is controlled according to a process ID in this embodiment, it is also possible to control the cache according to a task ID in a system configuration where processing is managed on a task execution basis, for example, by the real-time monitor. In addition, it is also possible to apply the present invention not only to a controller dedicated to control operations but also to any operation control device.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A cache controller comprising:
a storage unit having at least one correspondence between a process identifier and configuration information specifying a cache access mode stored therein; and
a control circuit for receiving a process identifier supplied from a CPU on which a process is executed, obtaining configuration information corresponding to the process identifier from said storage unit and, based on the configuration information obtained, variably controlling the access mode of a cache for the process executed on said CPU.

2. The cache controller according to claim 1, wherein the cache access mode is variably controlled according to execution property of the process.

3. The cache controller according to claim 1, wherein, as the correspondence between the process identifier and the configuration information,
said storage unit stores at least one of correspondences of
process identifier and cache nonuse,
process identifier and cache use with permission of cache contents replacement, and
process identifier and cache use with no-permission of cache contents; and
wherein said control circuit receives the process identifier from said CPU, obtains configuration information corresponding to the process identifier from said storage unit, and, based on the configuration information obtained, controls the cache use and nonuse and/or the permission and no-permission of cache contents replacement for the process executed on said CPU.

4. The cache controller according to claim 1, wherein, as the correspondence between the process identifier and the configuration information,
said storage unit stores at least one of correspondence between process identifier and cache use/nonuse; and
wherein said control circuit receives a process identifier from a CPU, obtains configuration information corresponding to the process identifier from said storage unit and, based on the configuration information obtained, controls cache use and nonuse for each process executed on said CPU.

5. The cache controller according to claim 1, wherein, as the correspondence between the process identifier and the configuration information,
said storage unit stores at least one of correspondences between a process identifier and permission/no-permission of cache contents replacement; and
wherein said cache controller receives a process identifier from a CPU, obtains configuration information corresponding to the process identifier from said storage unit and, based on the configuration information, controls the permission/no-permission of cache contents replacement for each process executed on said CPU.

6. The cache controller according to claim 1, wherein the correspondence between the process identifier and the configuration information is set associated with execution property of a program managed by an operating system running on said CPU.

7. A controller device comprising:
a CPU;
a cache; and
a cache controller,
wherein said cache controller includes:
a storage unit having at least one correspondence between a process identifier and configuration information specifying a cache access mode stored therein; and
a control circuit for receiving a process identifier supplied from said CPU on which a process is executed, obtaining configuration information corresponding to the process identifier from said storage unit and, based on the configuration information obtained, variably controlling the access mode of a cache for the process executed on said CPU.

8. The controller device according to claim 7, wherein a storage unit in which data and/or instructions are stored is provided internally or externally to said controller.

9. The controller device according to claim 7, wherein, as the correspondence between the process identifier and the configuration information,
said storage unit stores at least one of correspondences of
process identifier and cache nonuse,
process identifier and cache use with permission of cache contents replacement, and
process identifier and cache use with permission of cache contents; and
wherein said control circuit receives the process identifier from said CPU, obtains configuration information corresponding to the process identifier from said storage unit, and, based on the configuration information obtained, controls the cache use and nonuse and/or the permission and no-permission of cache contents replacement for the process executed on said CPU.

10. The controller device according to claim 7, wherein, as the correspondence between the process identifier and the configuration information,
said storage unit stores at least one of correspondence between process identifier and cache use/nonuse; and
wherein said control circuit receives a process identifier from a CPU, obtains configuration information corresponding to the process identifier from said storage unit and, based on the configuration information obtained, controls cache use and nonuse for each process executed on said CPU.

11. The controller device according to claim 7, wherein, as the correspondence between the process identifier and the configuration information,
said storage unit stores at least one of correspondences between a process identifier and permission/no-permission of cache contents replacement; and
wherein said cache controller receives a process identifier from a CPU, obtains configuration information corresponding to the process identifier from said storage unit and, based on the configuration information, controls the permission/no-permission of cache contents replacement for each process executed on said CPU.

12. The controller device according to claim 7, wherein the correspondence between the process identifier and the configuration information is set associated with execution property of a program managed by an operating system running on said CPU.

13. The controller device according to claim 7, wherein, if the configuration information corresponding to the process identifier indicates cache nonuse, said cache controller performs control, for a read access made from said CPU, so that said cache is not accessed but contents read from said storage unit are supplied to said CPU.

14. The controller device according to claim 7, wherein, if the configuration information corresponding to the process identifier indicates cache use with permission of cache contents replacement, said cache controller performs control for a read access issued from said CPU, so that contents read from said cache are sent to said CPU if a cache hit occurs, while contents read from said storage unit are sent to said CPU and at the same time, contents stored in said cache are replaced with the contents read from said storage unit, if a cache miss occurs.

15. The controller device according to claim 7, wherein, if the configuration information corresponding to the process identifier indicates cache use with no-permission of cache contents replacement, said cache controller performs control for a read access made from said CPU so that contents read from said cache are sent to said CPU if a cache hit occurs, while contents read from said storage unit are sent to said CPU and replacement of contents stored in said cache with the contents read from said storage unit is not performed, if a cache miss occurs.

16. The controller device according to claim 7, wherein said storage unit comprises a non-volatile memory in which at least instructions executed on said CPU are stored; and
wherein said cache stores instructions executed on said CPU.

17. A cache control method comprising the steps of:
a CPU supplying a process identifier of a process which is executed on said CPU, to a cache controller;
said cache controller, on receipt of the process identifier supplied from said CPU, obtaining configuration information corresponding to the received process identifier by retrieving a storage unit in which at least one correspondence between a process identifier and configuration information specifying a cache access mode is stored; and
said cache controller variably controlling access mode of a cache for the process based on the configuration information.

18. The cache control method according to claim 17, wherein the cache access mode is variably controlled according to execution property of the process.

19. The cache control method according to claim 17, wherein, as the correspondence between the process identifier and the configuration information,
said storage unit stores at least one of correspondences of
process identifier and cache nonuse,
process identifier and cache use with permission of cache contents replacement, and
process identifier and cache use with no-permission of cache contents replacement; and
wherein said cache controller receives the process identifier from said CPU, obtains configuration information corresponding to the process identifier from said storage unit, and, based on the configuration information, controls the cache use and nonuse and/or the permission and no-permission of cache contents replacement for the process executed on said CPU.

20. The cache control method according to claim 17, wherein the correspondence between the process identifier and the configuration information is set associated with execution property of a program managed by an operating system running in said CPU.
